(19) United States
(12) Patent Application Publication
(10) Pub. No.: US 2005/0249275 A1
(43) Pub. Date: Nov. 10, 2005

(54) Timing recovery method and device for combining pre-filtering and feed-forward equalizing functions

(75) Inventors: Ming-Chou Yen, Hsin Chu (TW); Chun-Wang Wei, Hsin Chu (TW); Kun-Ying Tsai, Hsin Chu (TW); Jui-Tai Ko, Hsin Chu (TW)

Correspondence Address: EDWARDS & ANGELL, LLP, P.O. BOX 55874, BOSTON, MA, 02205, US

(73) Assignee: RDC Semiconductor Co., Ltd.

(21) Appl. No.: 10/964,516

(22) Filed: Oct. 12, 2004

(30) Foreign Application Priority Data
May 4, 2004 (TW) 093112480

(51) Int. Cl. H04L 27/14

(52) U.S. Cl. 375/232; 375/350; 375/355

(57) ABSTRACT

Timing recovery method and device for combining pre-filtering and feed-forward equalizer functions are proposed and used in a digital communication system. A signal receiver is provided to receive a signal transmitted from a signal transmitter in the communication system, and recovers a sampling clock phase of the received signal to the phase of the signal transmitted from the signal transmitter. The method is used to control the signal receiver to transform the received signal to a signal similar to a Nyquist pulse after the pre-filtering and feed-forward equalizing operations are performed on the received signal, thereby improving the performance of the following sampling timing recovery process and increasing the signal noise ratio (SNR) of the received signal.

### FIELD OF THE INVENTION

The invention relates to timing recovery methods and devices for combining pre-filtering and feed-forward equalizing functions, and more particularly, to a timing recovery method and device used in a digital communication system for enabling a signal receiver to recover a sampling clock phase of a received signal during signal reception.

### BACKGROUND OF THE INVENTION

Referring to FIG. 1, where a block schematic diagram illustrating a signal transmission and reception in a conventional digital communication system is shown. The digital communication system includes a signal transmitter 100, a communication channel 200 and a signal receiver 300. The digital communication process is stated as follows: firstly, the signal transmitter 100 inputs a digital signal into a modulator 110 to be modulated to an analog signal, and then the analog signal is transmitted to a transmitting filter (Tx. filter) 120 for filtering other unwanted energy outside the transmitted signal bandwidth, then the processed analog signal is transmitted to the communication channel 200. The signal receiver 300 receives the analog signal from the communication channel 200 and transmits the analog signal to an analog to digital converter 310 for sampling the received analog signal by a predetermined sampling clock period and phase, and the sampled signal is inputted to an equalizer 320. The equalizer 320 compensates the sampled signal according to the distortion made by the communication channel 200, and the compensated signal is inputted to a symbol slicer module 330. The symbol slicer module 330 compares the value of the compensated signal with a plurality of the threshold values to obtain the threshold value corresponding to the compensated signal and generates a digital symbol signal corresponding to the threshold value. The signal receiver 300 processes received signal to produce a digital symbol signal as the final digital signal.

Although the sampling clock period of the signal receiver 300 can be pre-controlled to be similar to the signal transmitter 100, the sampling clock phase of the signal receiver 300 cannot be pre-controlled to be synchronous with the signal transmitter 100, thus the sampling clock phase must be recovered for reducing error rate of the received digital signal. The recovery of the sampling clock phase is performed by a timing recovery module 340, the recovery method is disclosed in article of Mueller and Muller “Timing Recovery in Digital Synchronous Data Receivers” IEEE Trans. Comm., Vol. COM-24, No. 5, PP. 516-531, May 1976. The method enables timing recovery module 340 to perform a correlation operation of the signals of the symbol slicer module 330 before and after inputting to obtain a timing function value. The timing function value is changed with respect to change of the sampling clock phase. When the sampling clock phase is an optimized phase, that is, when error rate of the received digital signal is minimal, the value of the timing function is zero.

According to the stated of the article, the timing function is given by the following expression:
f(τ)=½(h₁−h₋₁)

Wherein τ is the sampling clock phase, h₌₁=(T+τ) and h₁=(T+τ) denote two sampling points of total channel impulse response from the modulator 110 to the equalizer 320 via the transmitting filter 120, the communication channel 200 and the analog to digital converter 310, and T is a sampling clock period. FIG. 2(a) illustrates a correlation between amplitude and time of the channel impulse response, the marks “o” and “x” respectively indicate sampling with the same sampling clock period T but different sampling clock phase τ, the phase difference between the marks “o” and “x” is Δτ. After being sampled, the sampling points h₋₁, h₀, and h₁ are obtained. It is clearly shown that the mark “o” can achieve a highest value of the channel impulse response, but the mark “x” cannot. Since the mark “o” can achieve the highest value, it allows the sampled signal to have a higher noise resistance; this sampling clock phase is an optimized phase. Substituting the values of h₋₁ and h₁ of the marks “o” and “x” into the timing function f(τ)=½(h₁−h₋₁) obtains a similar correlation. Substituting the values h₋₁ and h₁ of the marks “o” into the timing function f(τ)=½(h₁−h₋₁), f(τ)=0, however, it is not the case for mark “x” . Therefore, when the timing function f(τ)=0, the sampling clock phase is the optimized phase.

FIG. 2(b) illustrates a correlation between the timing function f(τ) and Δτ/T based on the optimized sampling clock phase of the mark “o”, wherein T is the sampling clock period, Δτ is the phase difference between the sampling phase and the optimized sampling phase τ. The mark “o” in FIG. 2(b) is a value of the timing function by substituting sampled values marked “o” in FIG. 2(a) into the timing function, and the mark “x” in FIG. 2(b) is a value of the timing function by substituting sampled values marked “x” in FIG. 2(a) into the timing function. As shown in FIG. 2(b), whether the sampling clock phase is optimized can be identified by identifying whether the value of the timing function f(τ) is zero, and estimating the sampling clock phase is adjusted to be advanced or delayed to obtain the phase of the optimized sampling clock depending on the value of the timing function f(τ) is a positive value or a negative value.

The method above uses signal of the symbol slicer 330 before and after inputting to perform correlation operation to obtain the timing function, and further recovers the sampling clock phase back to the optimized sampling clock phase depending on the value of the timing function. Although the sampling clock phase can be achieved through this method, in actual operation, the extraction position of input signal of sampling timing recovery module 340 will affect the work of the timing recovery. Conventionally, there are two extraction positions of signal. Firstly, the input signal can be extracted after having been processed by the equalizer 320. Secondly, the input signal can be extracted before being processed by the equalizer 320. For timing recovery, there are several drawbacks about these two extraction positions of the input signal 7 of the sampling timing recovery module 340. The drawbacks are stated as follows.

When the signal is extracted after received signal being processed by the equalizer 320, the extracted signal is changed with respect to the change of the equalizer 320, the value of the timing function is changed according to the correlation operation performed on the extracted signal and the output signal of symbol slicer module 330, thus the timing recovery cannot proceed successfully. Equalizer 320 has to adapt to different channel characteristics caused by distance and environment variation of the communication channel 200 to compensate for channel distortion. This accounts for the change of the equalizer 320. Thus, the equalizer 320 usually has an adaptive function, such as an adaptive equalizer, the adaptive equalizer need an adaptive period to output a stable signal, if the signal is inputted to the sampling timing recovery module 340 during the adaptive period, the work of sample timing recovery cannot be achieved.

Referring to FIG. 3, it illustrates the result of performing timing recovery on unstable signal output from the equalizer 320 with adaptive function. The result was published in a conference paper by S. Haar, D. Daecke and R. Zukunft, T. Magesacher, titled “Equalizer-Based Symbol-Rate Timing Recovery for Digital Subscriber Line Systems”, Proc. IEEE Globecom 2002, Taipei, Taiwan, November 2002.

FIG. 3(a) illustrates a correlation between Δτ/T and the number of symbols, wherein Δτ indicates the phase difference with the optimized sampling timing phase τ, T denotes the sampling timing period. As shown in FIG. 3(a), during the adjustment period of the adaptive equalizer, the error of the sampling clock phase of the sampling timing recovery module 340 is bigger with increasing number of symbols. FIG. 3(b) illustrates the correlation between MSE (Mean Square Error) and the number of symbols, similar to the result of FIG. 3(a), the MSE is bigger with increasing number of symbols.

If the received signal is extracted before being processed by the equalizer 320, the extracted signal is not affected by the equalizer 320, yet errors in digital symbol 5 signal are still being generated because of initial error of comparing process at the symbol slicer module 330, when the error digital symbol signal is inputted to the sampling timing recovery module 340 to perform the sampling timing recovery, longer acquisition time is caused and the errors are difficult to reduce, as shown in FIG. 4 illustrating the correlation between the MSE and the number of symbol, after many symbols are generated, the MSE still cannot be reduced.

Therefore, how to avoid said problems in sampling timing phase recovery and rapidly recover the optimized sampling timing phase during signal reception is a problem to be resolved.

### SUMMARY OF THE INVENTION

In light of the drawbacks above, the primary objective of the present invention is to provide a timing recovery method and device used in a digital communication system for enabling a signal receiver to recover a phase of a signal transmitter from a sampling clock phase of a received signal when receiving the signal transmitted from the signal transmitter.

In accordance with the above and other objectives, the present invention proposes a timing recovery device combining pre-filter and feed-forward equalizer functions. The timing recovery device is used in a digital communication system for enabling a signal receiver to recover a sampling clock phase of a received signal during signal reception. The timing recovery device comprises:
an analog to digital converter for sampling the continuous received signal by an initially predetermined sampling clock phase to generate a discrete first signal and output the first signal;
a pre-filtering feed-forward equalizer for receiving the first signal and performing an Nyquist pulse process to the first signal to generate a second signal and output the second signal;
a symbol slicer module for receiving a third signal and comparing amplitude of the third signal with a plurality of threshold amplitudes to obtain a threshold amplitude corresponding to the third signal and generate a fourth signal corresponding to the threshold amplitude, the fourth signal being the final output signal of the receiver, the third signal being generated by subtracting the second signal from a sixth signal, the sixth signal being generated through an adaptive feedback equalizer receiving the fourth signal and adjusting the fourth signal according to a fifth signal, the fifth signal being generated by subtracting the third signal from the fourth signal, and the adaptive feedback equalizer being adapted for channel characteristic difference because of distance change and circumstance change of a subscriber loop; and
a sampling timing recovery module for receiving the second signal and the fourth signal and substituting the amplitude of the second signal to a timing function to figure out a timing function value, estimating the sampling clock phase should be advanced or delayed according to the timing function value, and sending a control signal to the analog to digital converter to adjust the sampling clock phase of the receiving signal to be advanced or delayed.

The present invention further proposes a timing recovery method combining pre-filter and feed-forward equalizer functions. The timing recovery method is used in a digital communication system for enabling a signal receiver to recover a sampling clock phase of a received signal during signal reception, the timing recovery method comprising the steps of:
enabling an analog to digital converter to sample the continuous received signal by an initial predetermined sampling clock phase to generate a discrete first signal and outputting the first signal;
enabling a pre-filtering feed-forward equalizer to receive the first signal, perform an Nyquist pulsing process to the first signal to generate a second signal and outputting the second signal;
enabling a symbol slicer module to receive a third signal, comparing amplitude of the third signal with a plurality of threshold amplitudes to obtain a threshold amplitude corresponding to the third signal, generating a fourth signal corresponding to the threshold amplitude, the third signal being generated by subtracting the second signal from a sixth signal, the sixth signal being generated through an adaptive feedback equalizer receiving the fourth signal and adjusting the fourth signal according to a fifth signal, the fifth signal being generated by subtracting the third signal from the fourth signal, and the adaptive feedback equalizer being adapted for channel characteristic difference because of distance change and circumstance change of a subscriber loop; and
enabling a sampling timing recovery module to receive the second signal and the fourth signal, substituting the amplitude of the second signal to a timing function to figure out a timing function value, estimating the sampling clock phase should be advanced or delayed according to the timing function value, and sending a control signal to the analog to digital converter to adjust the sampling clock phase of the receiving signal to be advanced or delayed.

### BRIEF DESCRIPTION OF THE DRAWINGS

The present invention can be more fully understood by reading the following detailed description of the preferred embodiments, with reference made to the accompanying drawings, wherein:

FIG. 1 (PRIOR ART) is a block schematic diagram illustrating a signal transmission and reception in a conventional digital signal communication system;

FIG. 2(a) (PRIOR ART) illustrates a correlation between amplitude and time of the channel impulse response at various sampling points, and FIG. 2(b) (PRIOR ART) illustrates the correlation between the timing function f(τ)=½(h1−h−1) corresponding to FIG. 2(a) and Δτ/T, wherein Δτ denotes a phase difference with the optimized sampling clock phase, T denotes a sampling clock period;

FIG. 3 (PRIOR ART) illustrates a timing recovery result of an unstable signal outputted by an adaptive equalizer, wherein FIG. 3(a) illustrates the correlation between Δτ/T and the number of symbol, wherein Δτ denotes the phase difference with the optimized sampling clock phase, T denotes the sampling clock period, FIG. 3(b) illustrates the correlation between MSE and the number of symbol;

FIG. 4 (PRIOR ART) illustrates a correlation between MSE and the number of symbol;

FIG. 5 is a block schematic diagram illustrating a signal transmission and reception in a digital signal communication system according to the present invention;

FIG. 6 illustrates an operation relation among an analog to digital converter, a symbol slicer module, a sampling timing recovery module and a filter equalizer, and further illustrates a more detailed configuration of the filter equalizer including a pre-filter feed-forward equalizer and an adaptive feedback equalizer;

FIG. 7 illustrates a correlation between time and amplitude of a Nyquist pulse, wherein the solid line indicates the correlation between time and amplitude of the Nyquist pulse, the sampling points “o” (h−4˜h4) are obtained from sampling with a phase τ when the value of the timing function f(τ)=½(h1−h−1) is zero;

FIG. 8 illustrates a correlation between time and amplitude of a general channel pulse response;

FIG. 9 illustrates a correlation between Δτ/T and amplitude of the timing function, wherein AT indicates the phase difference with the optimized sampling clock phase, T indicates the sampling clock period, the mark “o” is the result of the timing function obtained by the sampling timing recovery module after being processed by the pre-filtering feed-forward equalizer and, and the mark “+” is the result of the timing function only via the feed forward equalizer and the timing recovery module without pre-filtering;

FIG. 10 illustrates a correlation between MSE and the number of symbol after the signal is processed by the pre-filtering feed-forward equalizer; and

FIG. 11 illustrates the result of the signal after feed-forward equalizer, wherein the mark “o” is the result of the timing function processed by the pre-filtering feed-forward equalizer, and the mark “+” is the result of the timing function processed only by the feed forward equalizer without pre-filtering.

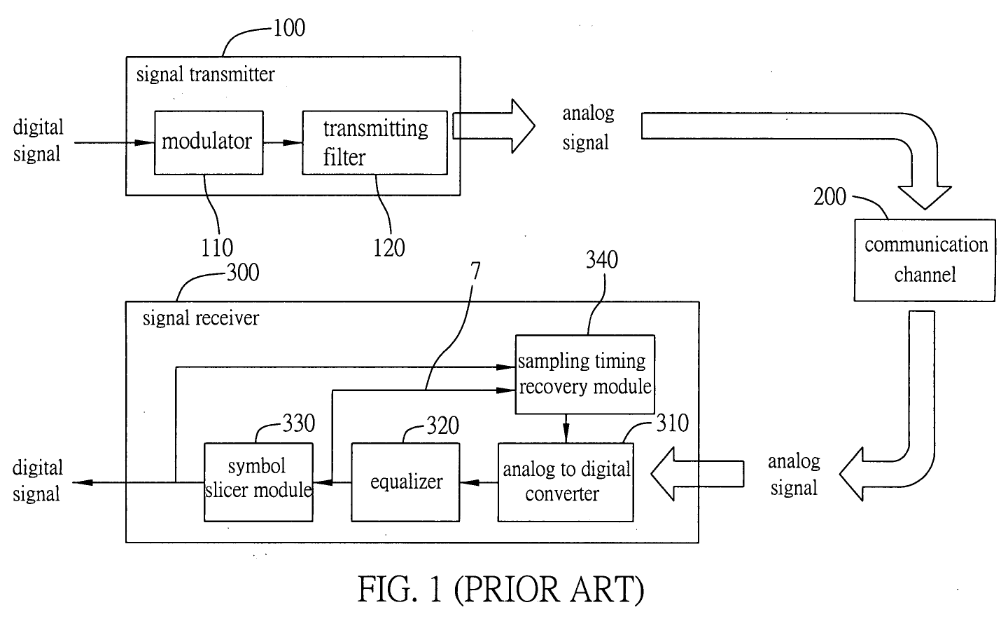

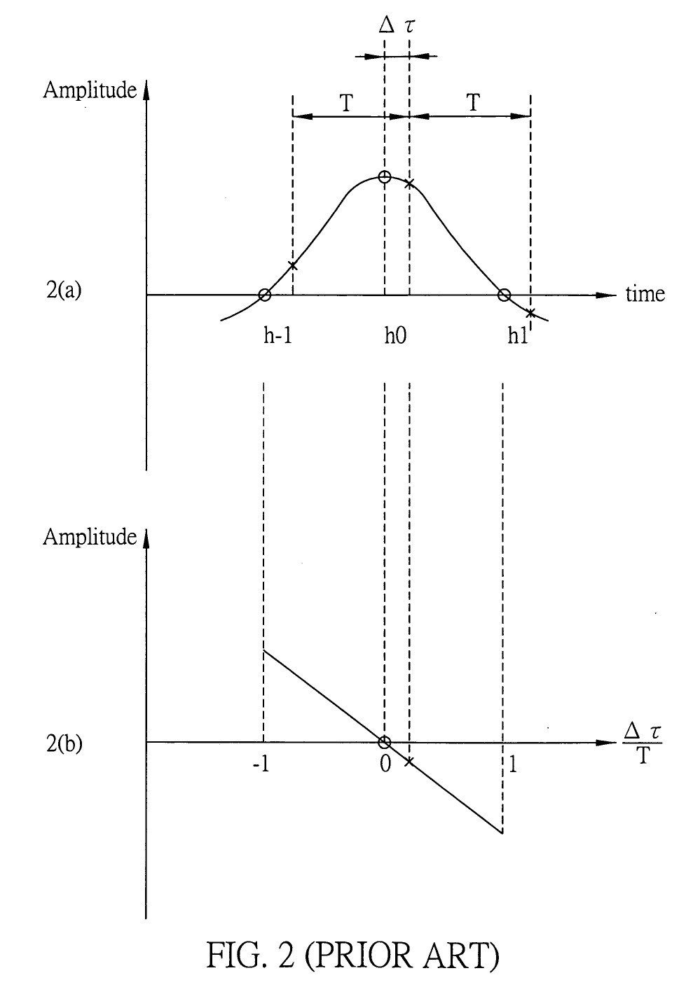

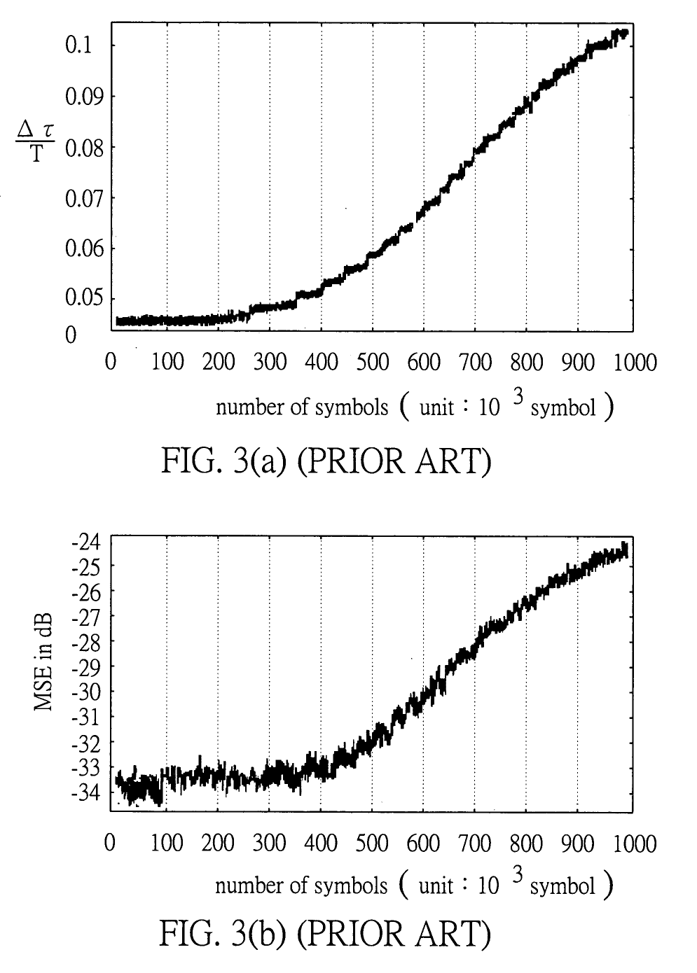

### DETAILED DESCRIPTION OF THE PREFERRED EMBODIMENTS

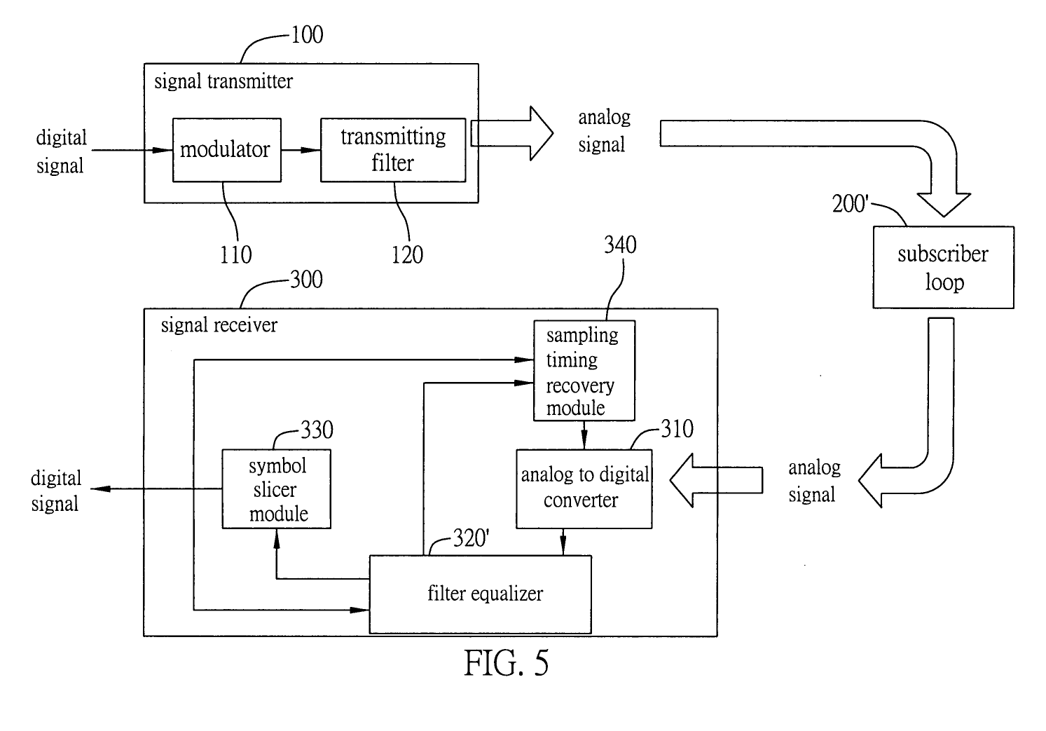

Referring to FIG. 5, which is a block schematic diagram illustrating a signal transmission and reception for a digital signal communication according to the present invention, a signal transmitter 100 is a transmitting terminal, a subscriber loop 200′ used in a digital communication channel is a communication transmitting medium, and a signal receiver 300 is a receiving terminal. A digital signal is processed by the signal transmitter 100 and is transmitted to the subscriber loop 200′, and is subsequently transmitted to the signal receiver 300 via the subscriber loop 200′ and then is processed by the signal receiver 300 to complete the communication flow of the communication signal. Particular communication process of the digital signal is stated as follows.

Firstly, a digital signal is inputted to the signal transmitter 100 and is modulated into an analog signal by a modulator 110, and then is transmitted to a transmitting filter 120 for filtering energy outside the wanted signal bandwidth, and finally, is transmitted to the subscriber loop 200′.

Secondly, the signal receiver 300 receives the analog signal from the subscriber loop 200′ and transmits the analog signal to an analog to digital converter 310. The analog to digital converter 310 samples the analog signal according to a predetermined sampling clock period and phase. The sampled signal is transmitted to a filter equalizer 320′.

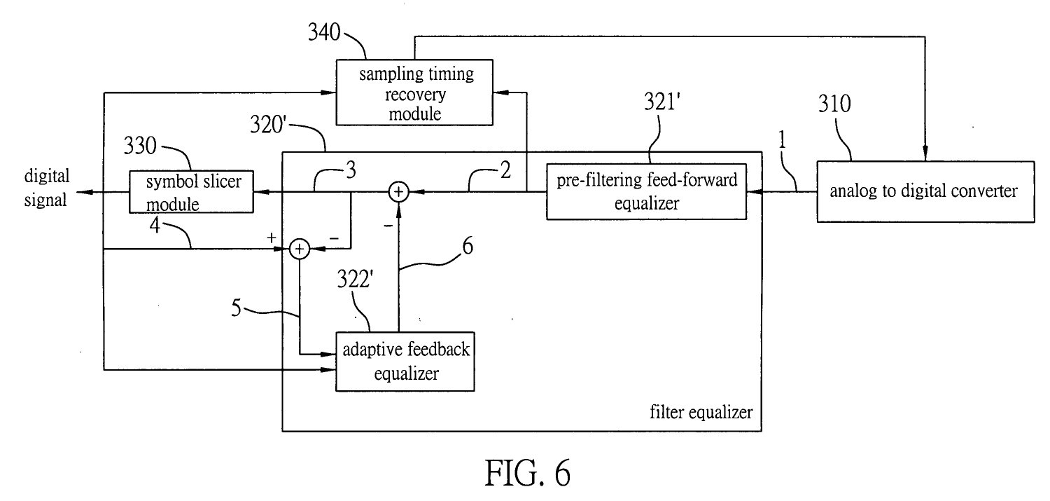

Referring to FIG. 6, FIG. 6 illustrates the operation relation among the analog to digital converter 310, a symbol slicer module 330, a sampling timing recovery module 340 and the filter equalizer 320′, and further illustrates a more detailed configuration of the filter equalizer 320′. The filter equalizer 320′ includes a pre-filtering feed-forward equalizer 321′ and an adaptive feedback equalizer 322′. The operation process of the filter equalizer 320′ is stated as follows.

Firstly, the pre-filtering feed-forward equalizer 321′ receives a first signal 1 from the analog to digital converter 310 and performs an Nyquist pulse process to the first signal 1 to generate a second signal 2, then outputs the second signal 2. The description of the Nyquist pulse is indicated in latter specification.

Secondly, the symbol slicer module 330 receives a third signal 3 and compares amplitude of the third signal 3 with a plurality of threshold amplitudes to obtain a threshold amplitude corresponding to the third signal 3, and then generates a final output digital signal, that is a fourth signal 4 corresponding to the threshold amplitude. The third signal 3 is generated based on a difference between the second signal 2 and a sixth signal 6 obtained by a subtraction operation. The adaptive feedback equalizer 322′ receives the fourth signal 4 and adjusts the fourth signal 4 according to a fifth signal 5 to generate the sixth signal 6. The fifth signal 5 is generated based on a difference between the third signal 3 and the fourth signal 4 obtained by a subtraction operation. The adaptive feedback equalizer 322′ is adapted for channel characteristic difference because of distance change and circumstance change of the subscriber loop 200′. The sampling timing recovery module 340 receives the second signal 2 and the fourth signal 4, and substitutes amplitude of the second signal 2 to a timing function f(τ)=½(h₁−h₋₁) to obtain a timing function value. The sampling clock phase is determined to be advanced or delayed according to a positive value or negative value of the timing function, and then sends a control signal to the analog to digital converter 310 to adjust the sampling clock phase to be advanced or delayed during signal reception.

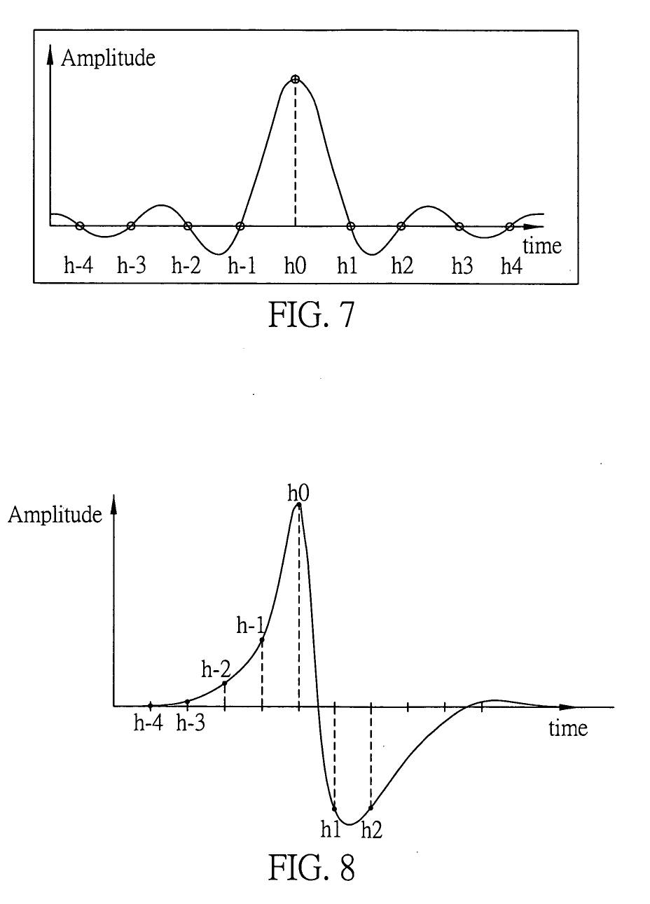

Referring to FIG. 7, FIG. 7 illustrates a channel pulse response of the Nyquist pulse. The solid line indicated a correlation between time and amplitude of the Nyquist pulse, the sampling points “o” (h₋₄˜h₄) are obtained from sampling with the phase τ when the value of the timing function f(τ)=½(h₁−h₋₁) is zero. The sampling points can achieve a maximal signal value (h₀). A correlation between time and amplitude of a general channel pulse response is shown in FIG. 8. Substituting the values h₁ and h₋₁ at the phase τ of the maximal signal value (h₀) into the timing function f(τ)=½(h₁−h₁), and the timing function value is not zero. So if the second signal 2 is processed by the Nyquist pulsing process of the pre-filtering feed-forward equalizer 321′, the second signal 2 is similar to the Nyquist pulse, thus the sampling clock phase τ when the value of the timing function f(τ)=½(h₁−h₋₁) is zero is near the optimized sampling clock phase so that the analog to digital converter 310 easily recovers the optimized sampling clock phase.

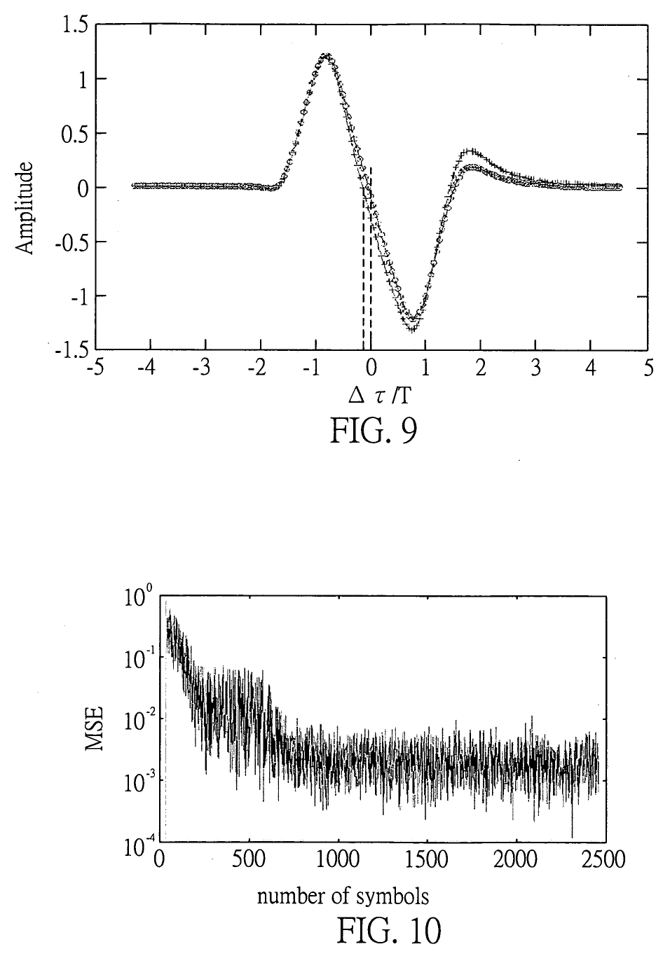

Referring to FIG. 9 illustrating a correlation between Δτ/T and amplitude of the timing function, wherein Δτ indicates the phase difference to the optimized sampling clock phase, T indicates the sampling clock period. The mark “o” indicates the result of the timing function obtained from the sampling timing recovery 340 after being processed by the pre-filtering feed-forward equalizer 321′, and the mark “+” indicates the result of the timing function obtained by the timing recovery module 340 after being processed by the feed-forward equalizer without pre-filtering. It is shown that the timing function processed by the pre-filtering feed-forward equalizer 321′ is propitious to estimate the optimized sampling clock, that is when the value of the timing function is zero, the phase difference (Δτ) to the optimized sampling clock phase is minimal.

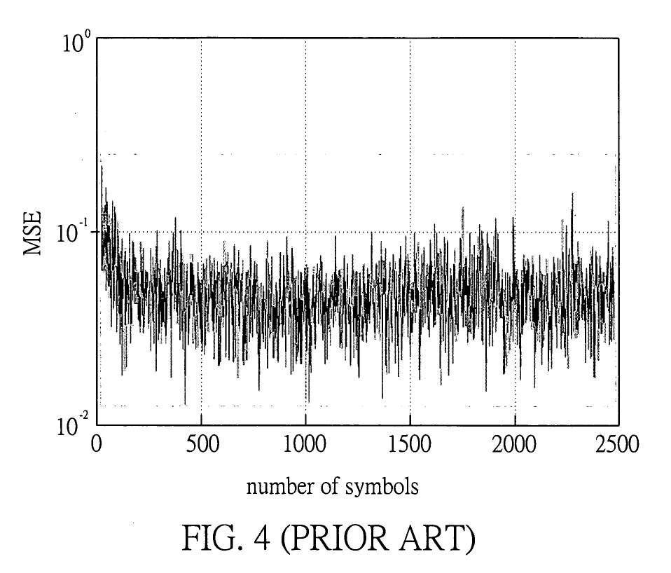

Referring to FIG. 10, it illustrates a correlation between MSE outputted by the symbol slicer module 330 and the number of symbol after the signal is processed by the pre-filtering feed-forward equalizer 321′. Compared with FIG. 4, the acquisition time of the present invention is short and the signal is stably convergent.

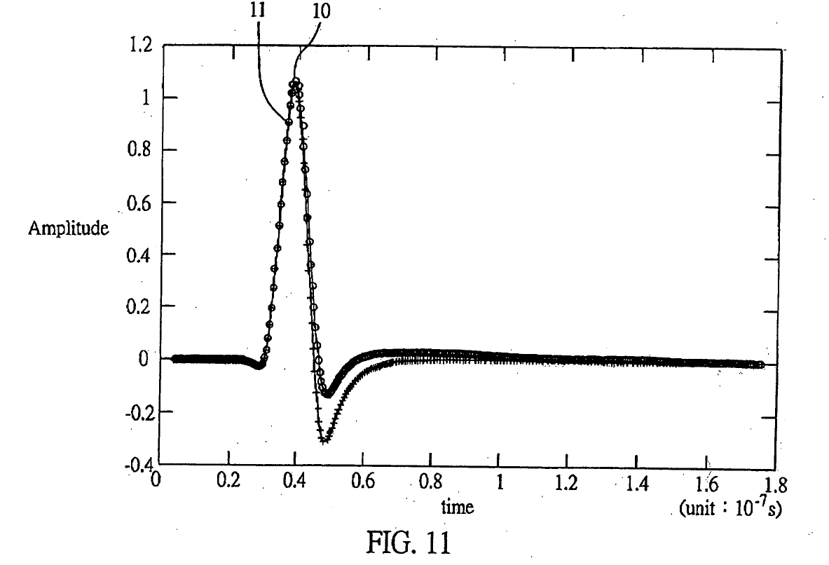

Referring to FIG. 11 illustrating a result of the signal after feed-forward equalizer, wherein the mark “o” indicates the result of the timing function processed by the pre-filtering feed-forward equalizer 321′, and the mark “+” indicates the result of the timing function processed by the feed-forward equalizer without pre-filtering. It is shown that after being processed by the pre-filtering feed-forward equalizer 321′, the signal can be sampled at sampling point 10 with highest amplitude so that the signal to noise ratio (S/N) for receiving signal is increased and the error ratio for receiving signal is reduced, but the signal processed by the feed-forward equalizer without pre-filtering can be only sampled at sampling point 11.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A timing recovery method for combining pre-filtering and feed-forward equalizing functions, for use in a digital communication system, so as to allow a signal receiver to recover a sampling clock phase of continuous signals received by the signal receiver, the timing recovery method comprising the steps of:
enabling an analog to digital converter to sample the continuous signals received by the signal receiver based on a predetermined sampling clock phase, so as to generate and output a discrete first signal;
enabling a pre-filtering feed-forward equalizer to receive the first signal and perform a Nyquist pulsing process on the first signal to generate and output a second signal;
enabling a symbol slicer module to receive a third signal and compare an amplitude of the third signal with a plurality of threshold amplitudes so as to obtain a threshold amplitude corresponding to the third signal and generate a fourth signal corresponding to the obtained threshold amplitude, wherein the third signal is generated based on a difference between the second signal and a sixth signal, the sixth signal is generated by an adaptive feedback equalizer receiving and adjusting the fourth signal according to a fifth signal, and the fifth signal is generated based on a difference between the third signal and the fourth signal, and wherein the adaptive feedback equalizer is adapted to different channel characteristics caused by changes of distance and circumstance of a subscriber loop; and
enabling a sampling timing recovery module to receive the second signal and the fourth signal and subject an amplitude of the second signal to a timing function to obtain a timing function value, so as to determine the sampling clock phase of the received continuous signals to be advanced or delayed according to the timing function value, and send a control signal to the analog to digital converter to adjust the sampling clock phase of the received continuous signals to be advanced or delayed based on the determination result.

2. The timing recovery method of claim 1, wherein the signal receiver comprises the analog to digital converter, the pre-filtering feed-forward equalizer, the adaptive feedback equalizer, the symbol slicer module and the sampling timing recovery module.

3. The timing recovery method of claim 1, wherein the timing function allows the second signal and the fourth signal to be subjected to a correlation operation so as to obtain the timing function value.

4. The timing recovery method of claim 3, wherein the timing function is ½(h₁−h₋₁).

5. The timing recovery method of claim 4, wherein the sampling timing recovery module determines the sampling clock phase of the received continuous signals to be advanced or delayed according to a positive value or a negative value of the timing function value.

6. A timing recovery device for combining pre-filtering and feed-forward equalizing functions, for use in a digital communication system, so as to allow a signal receiver to recover a sampling clock phase of continuous signals received by the signal receiver, the timing recovery device comprising:
an analog to digital converter for sampling the continuous signals received by the signal receiver based on a predetermined sampling clock phase so as to generate and output a discrete first signal;
a pre-filtering feed-forward equalizer for receiving the first signal and performing a Nyquist pulsing process on the first signal to generate and output a second signal;
a symbol slicer module for receiving a third signal and comparing an amplitude of the third signal with a plurality of threshold amplitudes so as to obtain a threshold amplitude corresponding to the third signal and generate a fourth signal corresponding to the obtained threshold amplitude, wherein the third signal is generated based on a difference between the second signal and a sixth signal, the sixth signal is generated by an adaptive feedback equalizer receiving and adjusting the fourth signal according to a fifth signal, and the fifth signal is generated based on a difference between the third signal and the fourth signal, and wherein the adaptive feedback equalizer is adapted to different channel characteristics caused by changes of distance and circumstance of a subscriber loop; and
a sampling timing recovery module for receiving the second signal and the fourth signal and subjecting an amplitude of the second signal to a timing function so as to obtain a timing function value and determine the sampling clock phase of the received continuous signals to be advanced or delayed according to the timing function value as well as send a control signal to the analog to digital converter to adjust the sampling clock phase of the received continuous signals to be advanced or delayed based on the determination result.

7. The timing recovery device of claim 6, wherein the signal receiver comprises the analog to digital converter, the pre-filtering feed-forward equalizer, the adaptive feedback equalizer, the symbol slicer module and the sampling timing recovery module.

8. The timing recovery device of claim 6, wherein the timing function allows the second signal and the fourth signal to be subjected to a correlation operation to obtain the timing function value.

9. The timing recovery device of claim 8, wherein the timing function is ½(h₁−h₋₁).

10. The timing recovery device of claim 9, wherein the sampling timing recovery module determines the sampling clock phase of the received continuous signals to be advanced or delayed according to a positive value or a negative value of the timing function value.
